(19) United States
(12) Patent Application Publication
(10) Pub. No.: US 2026/0164091 A1
(43) Pub. Date: Jun. 11, 2026

(54) USER TERMINAL AND OPERATING METHOD THEREOF

(71) Applicant: LG ELECTRONICS INC., Seoul (KR)

(72) Inventors: Jongtak Kim, Seoul (KR); Eunji Lim, Seoul (KR)

(73) Assignee: LG ELECTRONICS INC., Seoul (KR)

(21) Appl. No.: 19/417,065

(22) Filed: Dec. 11, 2025

(30) Foreign Application Priority Data
Dec. 11, 2024 (WO) PCT/KR2024/020264

(51) Int. Cl. H04N 21/488; H04N 21/431

(52) U.S. Cl. CPC H04N 21/4886; H04N 21/4312

(57) ABSTRACT

A user terminal according to an embodiment of the present disclosure may comprise a display; a communication circuit configured to communicate with a server or a display device; and a processor configured to: display a match event on the display based on either a notification received from the server or preferred sports setting information corresponding to a user account, receive a command to select the match event, and transmit a request for providing detailed information of a match corresponding to the match event to the display device through the communication circuit according to the received command.

### CROSS-REFERENCE TO RELATED APPLICATION

Pursuant to 35 U.S.C. § 119(a), this application claims priority to PCT Application No. PCT/KR2024/020264, filed on Dec. 11, 2024, the entity of which is incorporated by reference into the present application.

### BACKGROUND OF THE INVENTION

### 1. Field of the Invention

The present disclosure relates to a user terminal that links a display device and a sports service.

### 2. Discussion of the Related Art

Digital TV services using wired or wireless communication networks are becoming common. Digital TV services may provide various services which cannot be provided by the existing analog broadcast service.

For example, Internet protocol television (IPTV) and smart TV services which are types of digital TV services provide interactivity to allow user to actively select a type of a program to be watched, a viewing time, etc. The IPTV and smart TV services may provide various additional services, such as Internet search, home shopping and online matches, based on such interactivity.

Recent TVs offer services that display sports alerts for matches featuring the user's favorite team or player.

However, currently, TV is not connected to mobile, so there is a problem that sports notifications may only be checked while watching TV.

Additionally, there is a limitation that match information may only be viewed through sports-related apps installed on the TV.

### SUMMARY OF THE INVENTION

An object of the present disclosure may be to enable a user to be informed of match information even when the display device is not being viewed, through notifications on the user terminal.

The purpose of this disclosure may be to compensate for the inconvenience of having to continuously search for information related to a favorite team's match while away from home.

The purpose of the present disclosure may be to provide a service that allows viewing of real-time sports broadcasts by directly connecting the broadcasts to a display device without a complicated process.

A user terminal according to an embodiment of the present disclosure may comprise a display; a communication circuit configured to communicate with a server or a display device; and a processor configured to: display a match event on the display based on either a notification received from the server or preferred sports setting information corresponding to a user account, receive a command to select the match event, and transmit a request for providing detailed information of a match corresponding to the match event to the display device through the communication circuit according to the received command.

A method of operating a user terminal according to an embodiment of the present disclosure may comprise displaying a match event based on either a notification received from a server or preferred sports setting information corresponding to a user account;

receiving a command to select the match event; and transmitting a request for providing detailed information of a match corresponding to the match event to a display device according to the received command.

According to various embodiments of the present disclosure, a user may easily check match information even when the display device is not being viewed through a notification on the user terminal.

According to various embodiments of the present disclosure, the user experience may be improved by eliminating the need to search for match broadcasts of favorite teams or favorite players one by one.

According to various embodiments of the present disclosure, users do not need to separately manage the match times of their favorite teams or favorite players.

According to various embodiments of the present disclosure, when a user is unable to view a match, the inconvenience of having to continuously look up the score directly may be resolved.

### BRIEF DESCRIPTION OF THE DRAWINGS

FIG. 1 is a block diagram illustrating a configuration of a display device according to an embodiment of the present disclosure.

FIG. 2 is a block diagram of a remote control device according to an embodiment of the present disclosure.

FIG. 3 shows an example of an actual configuration of a remote control device according to an embodiment of the present disclosure.

FIG. 4 shows an example of using a remote control device according to an embodiment of the present disclosure.

FIG. 5 is a block diagram illustrating the configuration of a user terminal according to one embodiment of the present invention.

FIG. 6 is a drawing for explaining the configuration of a system according to one embodiment of the present disclosure.

FIG. 7a is a sequence diagram for explaining an operation method of a system according to an embodiment of the present disclosure, and FIG. 7b is a drawing for explaining an operation scenario of the system according to the embodiment of FIG. 7a.

FIG. 8 is a flowchart for explaining an operation method of a user terminal according to an embodiment of the present disclosure.

FIGS. 9A to 9C are drawings illustrating a process for registering preferred sports setting information according to an embodiment of the present disclosure.

FIGS. 10A to 10D are diagrams illustrating a process of providing detailed information on a live match when a live match exists based on preferred sports setting information according to one embodiment of the present disclosure.

FIGS. 11A to 11D are diagrams showing a process of providing information on a scheduled match when a scheduled match exists based on preferred sports setting information according to an embodiment of the present disclosure.

FIGS. 12A to 12D are diagrams illustrating a process for providing information related to a my sports alarm card based on preferred sports setting information according to an embodiment of the present disclosure.

### DETAILED DESCRIPTION OF THE PREFERRED EMBODIMENTS

Hereinafter, the present disclosure will be described in more detail with reference to the drawings. Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

The display device according to an embodiment of the present disclosure is, for example, an intelligent display device in which a computer support function is added to a broadcast reception function, and is faithful to a broadcast reception function and has an Internet function added thereto, such as a handwritten input device, a touch screen Alternatively, a more user-friendly interface such as a spatial remote control may be provided. In addition, it is connected to the Internet and a computer with the support of a wired or wireless Internet function, so that functions such as e-mail, web browsing, banking, or matches may also be performed. A standardized general-purpose OS may be used for these various functions.

Accordingly, in the display device described in the present disclosure, various user-friendly functions may be performed because various applications may be freely added or deleted, for example, on a general-purpose OS kernel. More specifically, the display device may be, for example, a network TV, HBBTV, smart TV, LED TV, OLED TV, and the like, and may be applied to a smart phone in some cases.

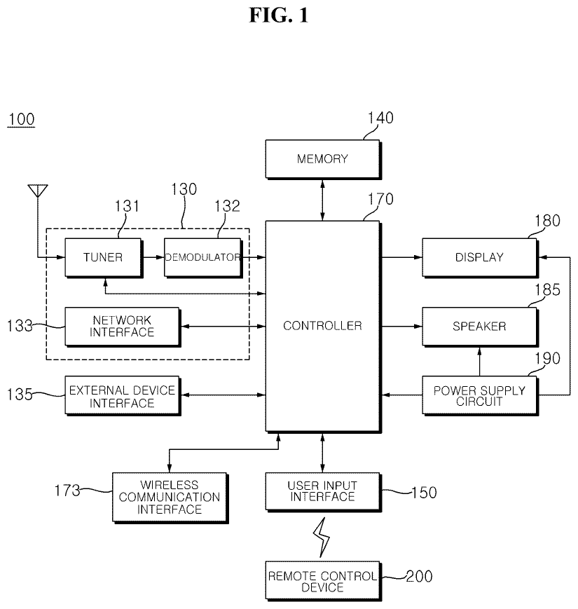

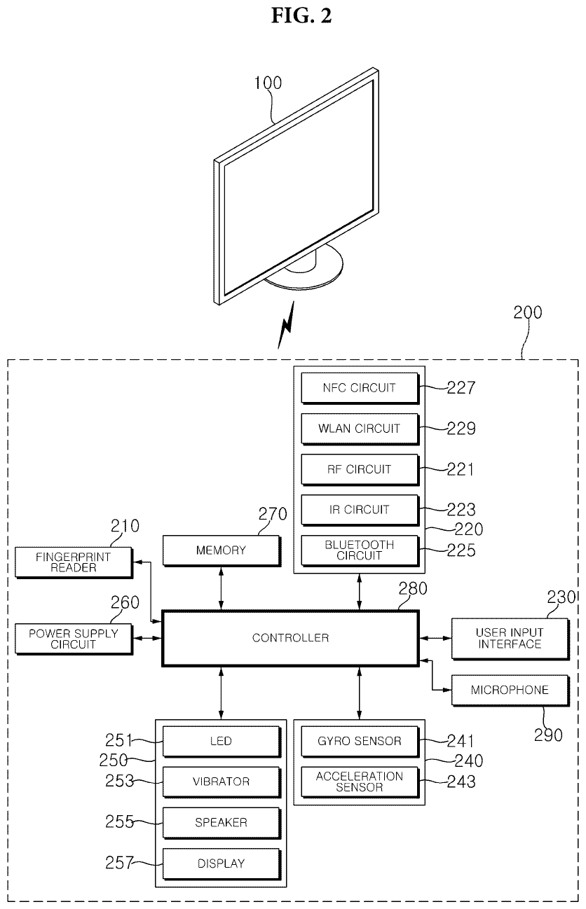

FIG. 1 is a block diagram showing a configuration of a display device according to an embodiment of the present disclosure.

Referring to FIG. 1, a display device 100 may include an image receiver 130, an external device interface 135, a memory 140, a user input interface 150, a controller 170, a wireless communication interface 173, a display 180, a speaker 185, and a power supply circuit 190.

The image receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface unit 135 may be output through the display 180. The audio signal of the external device input through the external device interface 135 may be output through the speaker 185.

The external device connectable to the external device interface 135 may be any one of a set-top box, a Blu-ray player, a DVD player, a match machine, a sound bar, a smartphone, a PC, a USB memory, and a home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a content provider or a network operator. That is, the network interface 133 may receive content such as movies, advertisements, matches, VOD, and broadcast signals and information related thereto provided from a content provider or a network provider through a network.

In addition, the network interface 133 may receive update information and update files of firmware provided by the network operator, and may transmit data to an Internet or content provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 the speaker 185.

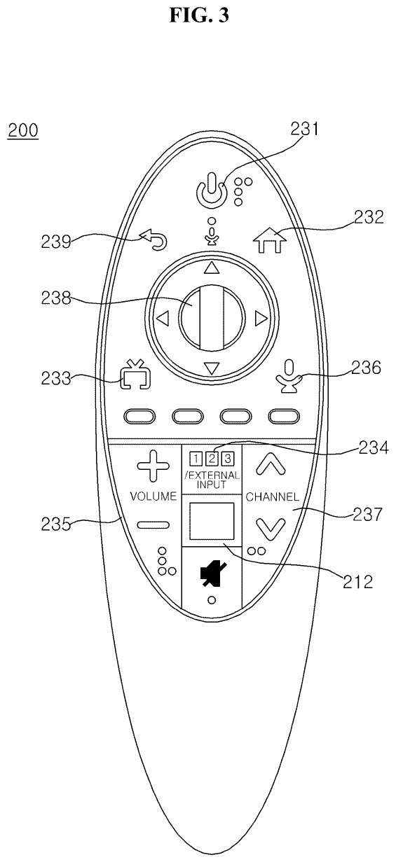

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation.

The power button 231 may be a button for turning on/off the power of the display device 100.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the level of the volume output by the display device 100.

The voice recognition button 236 may be a button for receiving a user's voice and recognizing the received voice.

The channel change button 237 may be a button for receiving a broadcast signal of a specific broadcast channel.

The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100.

The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication unit 225.

In addition, the power supply circuit 260 may supply power to the remote control device 200, and stop power supply when the remote control device 200 has not moved for a predetermined time to reduce power consumption.

The power supply circuit 260 may restart power supply when a predetermined key provided in the remote control device 200 is operated.

The memory 270 may store various types of programs and application data required for control or operation of the remote control device 200.

When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 230 or a signal corresponding to the movement of the remote control device 200 sensed by the sensor 240 through the wireless communication unit 225.

Also, the microphone 290 of the remote control device 200 may obtain a speech.

A plurality of microphones 290 may be provided.

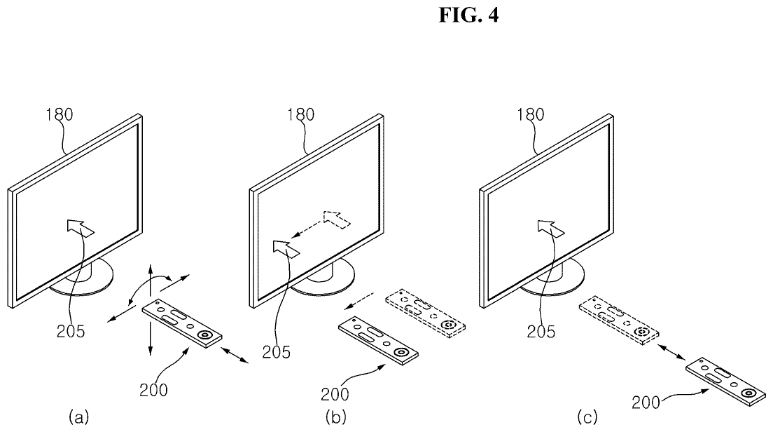

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

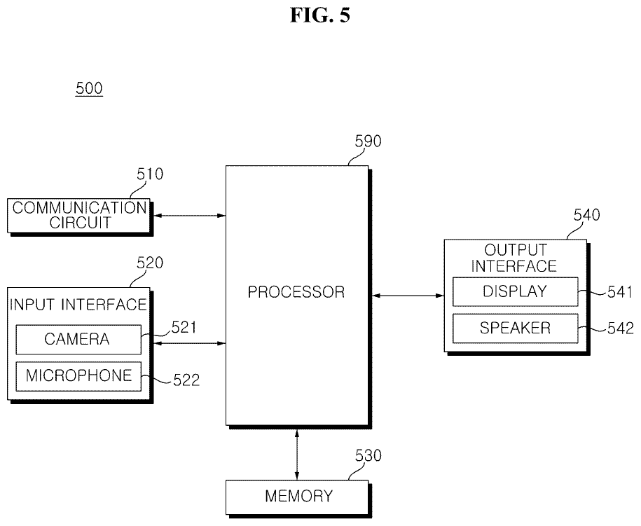

FIG. 5 is a block diagram illustrating the configuration of a user terminal according to one embodiment of the present invention.

The user terminal 500 may be implemented as a fixed or mobile device, such as a projector, a mobile phone, a smart phone, a desktop computer, a laptop, a digital broadcasting terminal, a personal digital assistant (PDA), a portable multimedia player (PMP), a navigation device, a tablet PC, a wearable device, a set-top box (STB), a DMB receiver, a radio, or a desktop computer.

Referring to FIG. 5, the user terminal 500 may include a communication circuit 510, an input interface 520, a memory 530, an output interface 540, and a processor 590.

The communication circuit 510 may transmit and receive data with external devices such as other user terminals or servers using wired or wireless communication technology.

The communication circuit 510 may perform communication using any one of the communication standards of GSM (Global System for Mobile communication), CDMA (Code Division Multi Access), LTE (Long Term Evolution), 5G, WLAN (Wireless LAN), Wi-Fi (Wireless-Fidelity), Bluetooth (Bluetooth), RFID (Radio Frequency Identification), Infrared Data Association (IrDA), ZigBee, and NFC (Near Field Communication).

The input interface 520 may include a camera 521 for inputting a video signal, a microphone 522 for receiving an audio signal, a user input interface for receiving information from a user, etc.

Here, the camera 521 or microphone 522 is treated as a sensor, and the signal obtained from the camera 521 or microphone 522 may be referred to as sensing data or sensor information.

The memory 530 may store various software and data related to the operation of the user terminal 500.

The output interface 540 may include a display 541 that displays a video signal received from the outside and a speaker 542 that outputs an audio signal.

The processor 590 may control the overall operation of the user terminal 500.

When connection of an external device is required to perform an operation of the user terminal 500, the processor 590 may generate a control signal for controlling the external device and transmit the generated control signal to the external device.

The processor 590 may control at least some of the components of the user terminal 500 to run an application program stored in the memory 530.

The processor 590 may operate two or more of the components included in the user terminal 500 in combination to drive the application program.

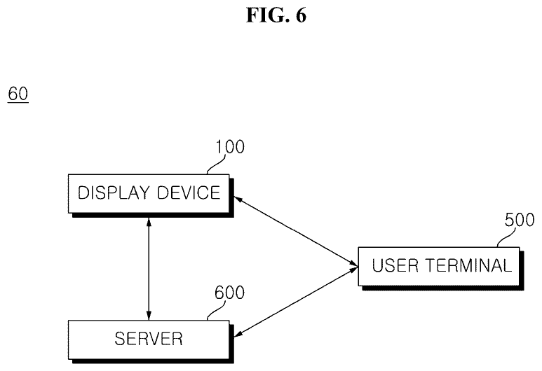

FIG. 6 is a drawing for explaining the configuration of a system according to one embodiment of the present disclosure.

Referring to FIG. 6, a system 60 may include a display device 100, a user terminal 500, and a server 600.

A home appliance management application may be installed on the user terminal 500. The home appliance management application may be an application for remotely controlling a home appliance located in a user's home through the user terminal 500.

The user terminal 500 may remotely control the home appliance by linking with the server 600 through the home appliance management application.

A sports service application may be installed on the display device 100 or the user terminal 500. The sports service application may be an application for providing information about a sports match.

An application may be referred to as an app.

The user terminal 500 may receive a notification based on preferred sports setting information from the server 600 through the communication circuit 510.

The user terminal 500 may display a match event on the display 541 based on either a received notification or pre-stored preferred sports setting information.

The user terminal 500 may receive a command to select the match event, and may transmit a request for providing detailed information of a match corresponding to the match event to the display device 100 through the communication circuit 510 according to the received command.

The display device 100 may drive a sports service app in response to a request received from a user terminal 500 and display detailed information of the match on a execution screen of the sports service app.

The server 600 may be provided in multiples. Each server may have a database.

The server 600 may transmit a control command to the display device 100 to control the display device 100 based on a command received from the user terminal 500.

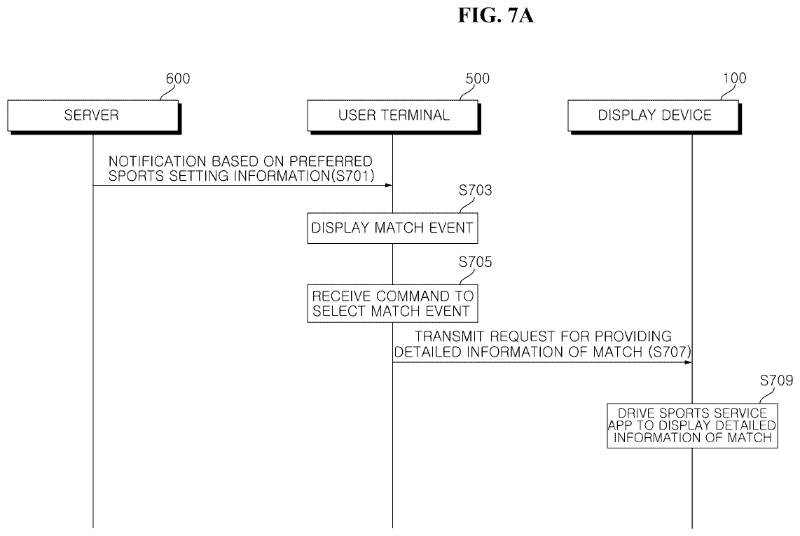

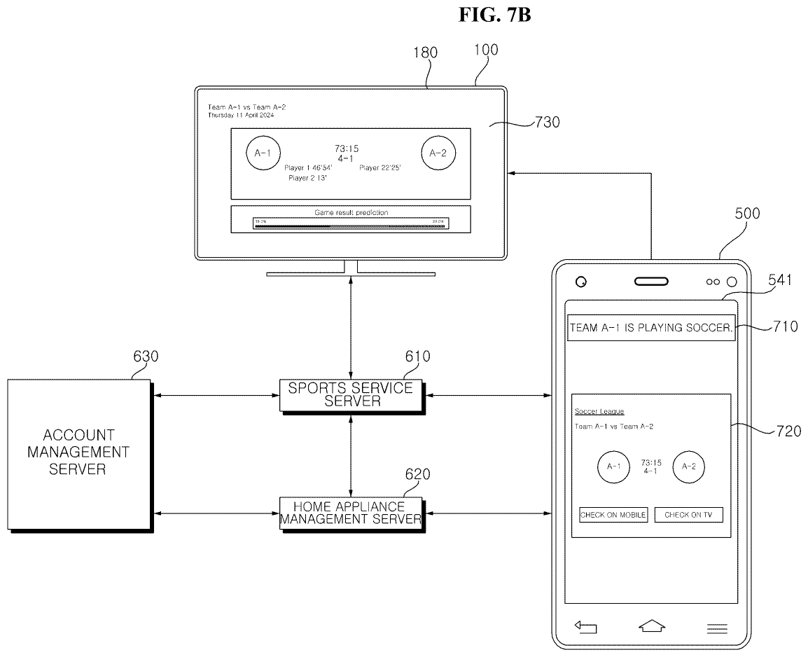

FIG. 7A is a sequence diagram for explaining an operation method of a system according to an embodiment of the present disclosure, and FIG. 7B is a drawing for explaining an operation scenario of the system according to the embodiment of FIG. 7A.

Below, the operations performed by the user terminal 500 may be operations performed after the home appliance management application is executed. Specifically, the operations performed by the user terminal 500 may be operations performed on the execution screen of the home appliance management application.

Referring to FIG. 7A, the processor 590 of the user terminal 500 may receive a notification based on preferred sports setting information from the server 600 through the communication circuit 510 S701.

The preferred sports setting information may include information about at least one of a preferred sports of the user, a preferred team of the user, and a preferred player of the user.

The preferred sports setting information may be stored in a database of the server 600.

In one embodiment, the user terminal 500 may receive the preferred sports setting information through a user input and transmit the received preferred sports setting information to the server 600.

In another embodiment, the display device 100 may receive the preferred sports setting information through the user input and transmit the received preferred sports setting information to the server 600.

The preferred sports setting information may vary depending on a user account.

The server 600 may generate a notification indicating an existence of a live match or scheduled match of a preferred team corresponding to the user account based on the preferred sports setting information, and transmit the generated notification to the user terminal 500.

The processor 590 of the user terminal 500 may display a match event based on either the received notification or the pre-stored preferred sports setting information on the display 541 S703.

In one embodiment, the match event may be either a notification message corresponding to the notification received from the server 600 or a match card based on preferred sports setting information stored in memory 530.

The match card may be either a live match card of a favorite team of the user account logged into the appliance management application or a scheduled match card representing an upcoming match.

In one embodiment, the processor 590 may display a notification message corresponding to the notification received from the server 600 on the display 541.

In another embodiment, the processor 590 may display a match card on the display 541 by selecting a TV item on the execution screen of the home appliance management application.

The processor 590 of the user terminal 500 may receive a command to select a match event S705, and may transmit a request for providing detailed information of a match corresponding to the match event to the display device 100 through the communication circuit 510 according to the received command S707.

In one embodiment, the processor 590 may transmit a request for providing detailed information about a corresponding match to the display device 100 via the communication circuit 510 according to a command to select the notification message corresponding to the notification received from the server 600.

In another embodiment, the processor 590 may transmit a request for providing detailed information about a match to the display device 100 through the communication circuit 510 in response to a command for selecting the match card displayed on the execution screen of the home appliance management application.

In another embodiment, the processor 590 may execute the sports service app on its own according to a command to select the notification message corresponding to the notification received from the server 600 and provide detailed information on the match through the sports service app.

In another embodiment, the processor 590 may execute the sports service app on its own in response to a command to select a match card and provide detailed information on the match through the sports service app.

The request to provide the detailed information of the match may be a request to provide match information such as information about the user's preferred team, the team's match date, a match time, and a live match video.

Meanwhile, the processor 590 may determine a power status of the display device 100, and if the power of the display device 100 is off, may transmit a power-on command to the display device 100 to turn on the power of the display device 100.

The processor 590 may receive the power status of the display device 100 from the server 600. The power status may be either a power-on state or a power-off state.

The processor 590 may transmit a request for providing the detailed information on the match to the display device 100 when the display device 100 is turned on.

As another example, when the processor 590 selects the notification message corresponding to the notification received from the server 600, the processor 590 may display on the display 541 a first button for viewing detailed information of a match corresponding to the notification on the user terminal 500 and a second button for viewing detailed information of a match corresponding to the notification on the display device 100.

As another example, when the match card is selected, the processor 590 may display on the display 541 the first button for viewing detailed information of the match corresponding to the notification on the user terminal 500 and the second button for viewing detailed information of the match corresponding to the notification on the display device 100.

The first button may be a user terminal execution button to be described later, and the second button may be a display device execution button to be described later.

The request may be a command to cause the display device 100 to run a sports service app to provide detailed information on the match corresponding to the match event. The request may include match information such as a team name and match time.

The display device 100 may drive a sports service app in response to a request received from a user terminal 500 and display the detailed information of the match on the execution screen of the sports service app S709.

The controller 170 of the display device 100 may execute the sports service app in response to a request received from a user terminal 500 and search for a match based on the match information included in the request. The controller 170 may obtain the detailed information on the match based on the search results for the match and display the detailed information on the match on the display 180.

The detailed information on the match may include at least one of the following: a match date, a match time, an opponent, a lineup for each team, a current performance of each team, an individual performance of a player, or a live broadcast video.

Referring to FIG. 7B, the server 600 may include a sports service server 610, a home appliance management server 620, and an account management server 630. The server 600 may be referred to as a server system.

The sports service server 610 may be linked with the display device 100 or the user terminal 500 through the sports service app.

The sports service server 610 may receive the preferred sports setting information of the user account from the display device 100 or the user terminal 500.

When the sports service server 610 receives the preferred sports setting information for a specific user account from the user terminal 500, it may transmit the received preferred sports setting information to the display device 100. When the specific user account logs in through the sports service app, the display device 100 may receive match information based on the preferred sports setting information received from the server 600.

The home appliance management server 620 may be linked with the user terminal 500 through the home appliance management application. The home appliance management server 620 may receive a notification based on the preferred sports setting information from the sports service server 610 and transmit the received notification to the user terminal 500.

The account management server 630 may be a server for managing multiple user accounts. The account management server 630 may store account information corresponding to each of the multiple user accounts. The account information may include one or more of the following: a name of an account, a password of the account, an email address of the account, and preferred sports settings information of the account.

The user terminal 500 may display a notification message 710 based on a notification received from the home appliance management server 620 on the display 541. The notification message 710 may be a message indicating that a live match of a preferred team is in progress based on the preferred sports setting information of the user account.

The user terminal 500 may request the display device 100 to provide detailed information on a live match according to a command to select the notification message 710.

The display device 100 may execute the sports service app according to a request received from the user terminal 500 and display detailed information 730 of a live match on the display 180. The detailed information 730 of the live match may include a broadcast video of the live match.

In this way, the user may watch a video of a real-time sports match on a large screen such as the display device 100 simply by selecting the notification message 710 without a complicated process.

In another embodiment, the user terminal 500 may display a live match card 720 indicating a live match of a preferred team on the display 180 based on the preferred sports setting information. The user terminal 500 may display the live match card 720 on the execution screen of the home appliance management application.

The live match card 720 may include information about a live match of the user's preferred team.

The user terminal 500 may transmit a request to the display device 100 to provide detailed information on a live match according to a command to select the live match card 720.

The display device 100 may execute the sports service app according to a request received from a user terminal 500 and display detailed information 730 of a live match on the display 180. The detailed information 730 of the live match may include a broadcast video of the live match.

In this way, the user may watch a video of a real-time sports match on a large screen such as the display device 100 simply by selecting the live match card 720 without a complicated process.

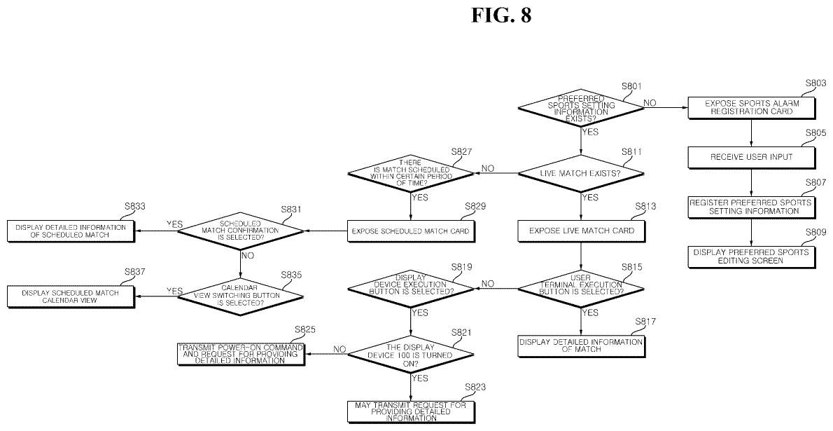

FIG. 8 is a flowchart for explaining an operation method of a user terminal according to an embodiment of the present disclosure.

A sports alarm registration card, a live match card, and a scheduled match card described in FIG. 8 may be examples of match events described in FIG. 7A.

The processor 590 of the user terminal 500 may determine whether preferred sports setting information exists S801.

The processor 590 may display an execution screen including a plurality of home appliance items on the display 541 as the home appliance management application is executed.

The processor 590 may enter a screen for managing a sports service based on an input for selecting a TV item among the plurality of home appliance items. The match card described below may be displayed on the screen for managing the sports service.

The processor 590 may determine whether the preferred sports setting information is stored for the user account.

The processor 590 of the user terminal 500 may expose a sports alarm registration card if the preferred sports setting information does not exist S803.

The sports alarm registration card may be a card to register a favorite team or a favorite player.

The processor 590 of the user terminal 500 may receive a user input for the sports alarm registration card S805 and register the preferred sports setting information according to the received user input S807.

The user input may be an input to select one or more preferred teams or one or more preferred players.

The processor 590 may store the preferred sports setting information including preferred teams or preferred players selected according to user input in the memory 530.

The processor 590 may transmit the stored preferred sports setting information to one or more of a sports service server 610 or a home appliance management server 620 via a communication circuit 510.

The processor 590 of the user terminal 500 may display a preferred sports editing screen for editing registered preferred sports setting information on the display 541 S809.

Steps S803 to S809 are described with reference to the drawings below.

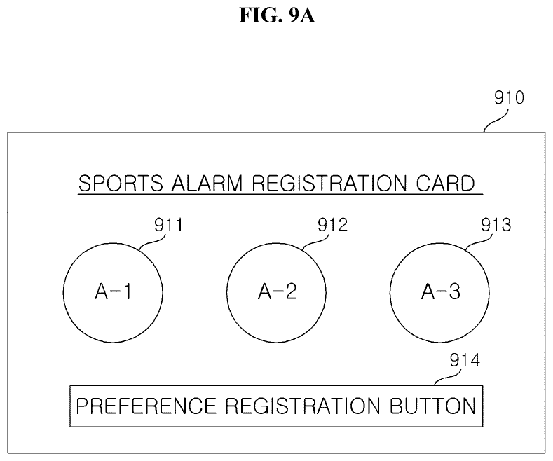

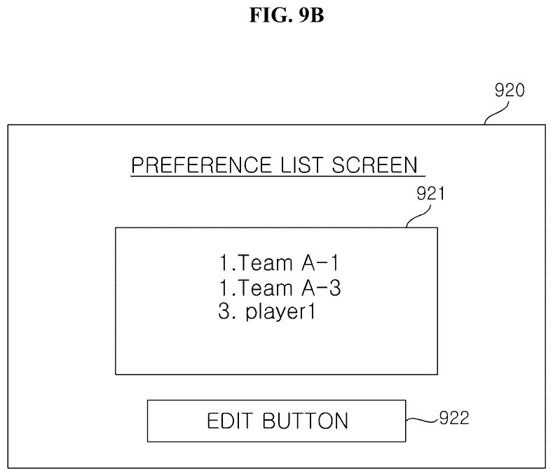

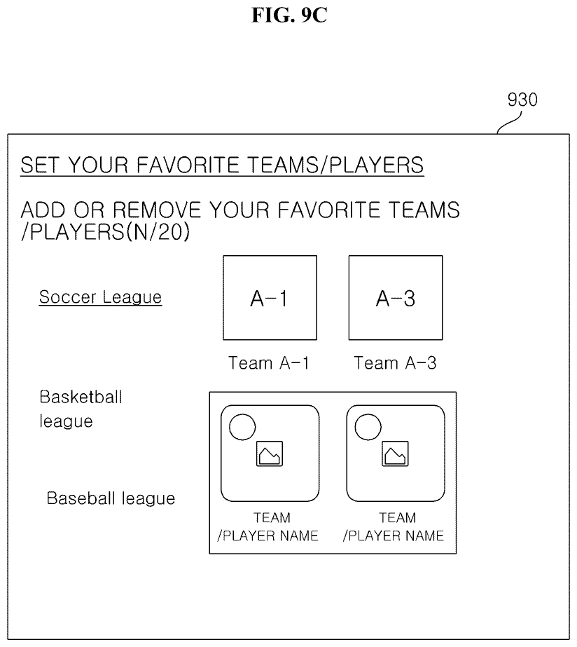

FIGS. 9A to 9C are drawings illustrating a process for registering preferred sports setting information according to one embodiment of the present disclosure.

Referring to FIG. 9A, a sports alarm registration card 910 is illustrated. If preferred sports setting information for a user account does not exist, the user terminal 500 may display the sports alarm registration card 910 on the display 541.

A sports alarm registration card 910 may include multiple teams 911, 912, 913, multiple players, and a preference registration button 914. The user terminal 500 may register the preference sports setting information by selecting one or more teams and one or more players, and then selecting the preference registration button 914.

When the preference registration button 914 is selected, the user terminal 500 may display a preference list screen 920 including a preference list 921 and an edit button 922 on the display 541, as shown in FIG. 9B.

The favorite list 921 may include teams and players selected on the sports alarm registration card 910.

The edit button 922 may be a button for adding or deleting a favorite team or a favorite player.

The user terminal 500 may display a preferred sports editing screen 930 on the display 541 as illustrated in FIG. 9C, according to an input selecting the edit button 922. The preferred sports editing screen 930 may be a screen for adding or deleting preferred teams or preferred players set by the user.

Again, FIG. 8 is explained.

Meanwhile, if the preferred sports setting information exists, the processor 590 of the user terminal 500 may determine whether a live match of the user's preferred team exists based on the preferred sports setting information S811.

The processor 590 may transmit a query to the sports service server 600 based on the preferred sports setting information to inquire whether a live match of the preferred team or preferred player exists. The processor 590 may determine whether the live match of the preferred team or preferred player exists based on a response query received in response to the query transmitted to the server 600.

The response query may include one or more of live match information or scheduled match information for the preferred team or the preferred player.

If the processor 590 of the user terminal 500 determines that the live match exists, it may expose a live match card on the display 541 S813.

The live match card may include some information about the live match of the favorite team or the favorite player.

The processor 590 of the user terminal 500 may determine whether the user terminal execution button included in the live match card is selected S815.

The live match card may include the user terminal execution button and a display device launch button.

The user terminal execution button may be a button for viewing detailed information of the live match on the user terminal 500.

The display device launch button may be a button for viewing detailed information of the live match on the display device 100.

When the user terminal execution button is selected, the processor 590 of the user terminal 500 may display detailed information of a match corresponding to the live match on the display 541 S817.

The processor 590 of the user terminal 500 may determine whether the display device execution button included in the live match card is selected S819.

When the display device execution button is selected, the processor 590 of the user terminal 500 may determine whether the display device 100 is turned on S821.

The processor 590 may receive information about the power status of the display device 100 from the home appliance management server 62.

The processor 590 of the user terminal 500 may transmit a request for providing detailed information on the live match to the display device 100 through the communication circuit 510 when the display device 100 is turned on S823.

The request to provide detailed information on the live match may be a request to provide match information such as a live match video, a lineup for each team, and a record for each player.

When the power of the display device 100 is turned off, the processor 590 of the user terminal 500 may transmit a power-on command and a request for providing detailed information on the live match to the display device 100 through the communication circuit 510 S825.

When the processor 590 determines that the display device 100 is powered off, it may transmit the power-on command through the communication circuit 510.

When the display device 100 is powered on, the processor 590 may transmit a request for providing detailed information on the live match to the display device 100 through the communication circuit 510.

Steps S811 to S825 are described with reference to the drawings below.

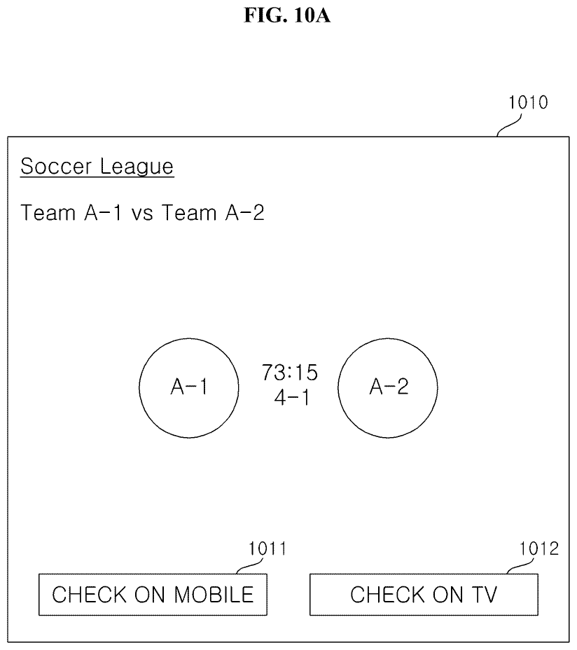

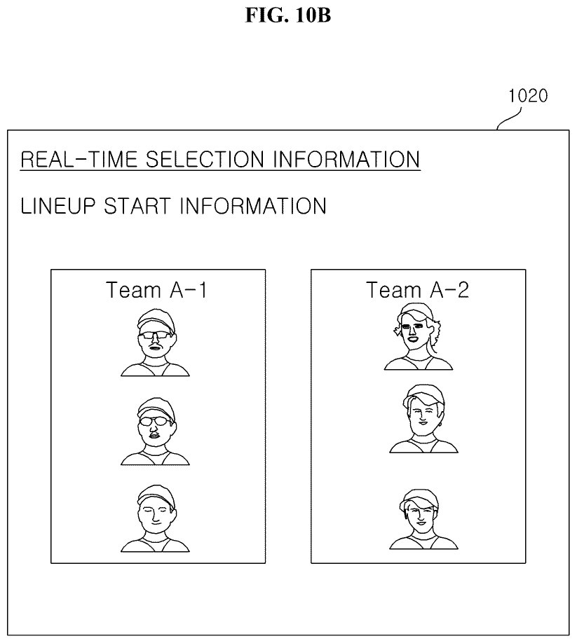

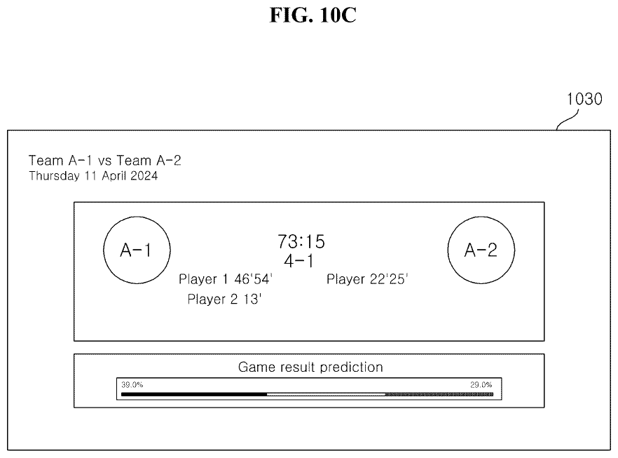

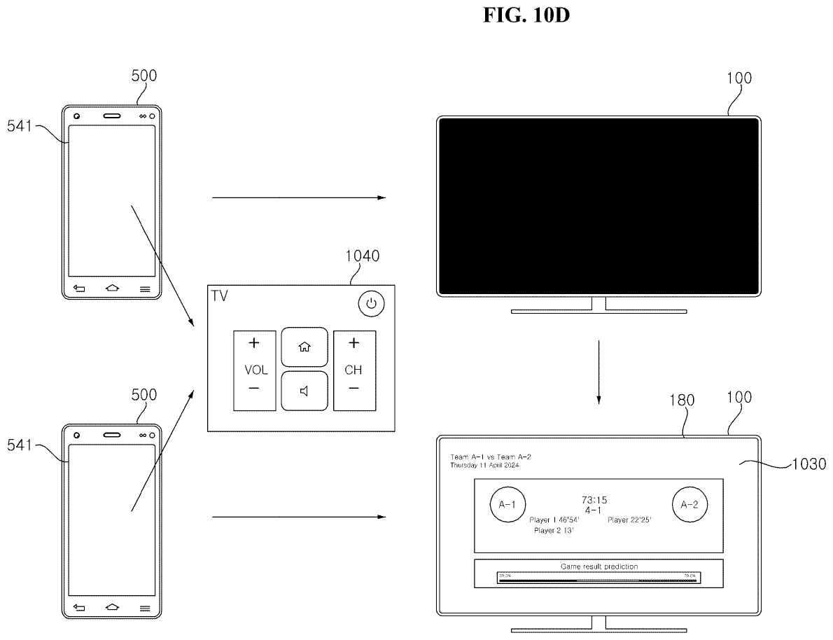

FIGS. 10A to 10D are diagrams illustrating a process of providing detailed information on a live match when a live match exists based on preferred sports setting information according to one embodiment of the present disclosure.

Referring to FIG. 10A, if the processor 590 of the user terminal 500 determines that a live match exists, it may display a live match card 1010 on the display 541.

The live match card 1010 may include a score of the live match of the favorite team, the match time, a user terminal run button 1011, and a display device run button 1012.

When the user terminal execution button 1011 is selected, the user terminal 500 may display detailed information 1020 of the live match on the display 541, as shown in FIG. 10B.

When the display device execution button 1012 is selected, the user terminal 500 may transmit a request to the display device 100 for providing detailed information on the live match.

The display device 100 may execute the sports service app in response to the request received from a user terminal 500, and, through the executed sports service app, may display a match details screen 1030 including detailed information of the live match on the display 180, as shown in FIG. 10C.

The match details screen 1030 may include a real-time score, a player record, match result prediction information, etc. The amount of information provided on the match details screen 1030 may be greater than the detailed information 1020 provided on the user terminal 500.

Meanwhile, as shown in FIG. 10D, when the display device 100 is turned off, the user terminal 500 may transmit a power-on command to the display device 100 before transmitting the request for providing detailed information on the match.

After the display device 100 is turned on, the user terminal 500 may transmit a request for providing detailed information on the match to the display device 100. In response to the received request, the display device 100 may display match details screen 1030 including detailed information on the live match on the display 180.

The user terminal 500 may display a remote control screen 1040 for controlling the operation of the display device 100 on the display 541 when the display device execution button 1012 is selected.

The user may control the operation of the display device 100 while watching detailed information of the live match through the remote control screen 1040.

Meanwhile, in FIG. 10A, the user terminal 500 may select a device to provide a video of the live match based on the user's viewing situation if the user terminal execution button 1011 and the display device execution button 1012 are not selected within a certain period of time.

For example, if it is determined that the user is watching the display device 100, the user terminal 500 may determine the device to provide the live match video as the display device 100. The user terminal 500 may transmit a request to the display device 100 for providing detailed information about the live match. The display device 100 may switch the currently playing broadcast video to the live match video according to the request. In other words, this may have the same effect as selecting the display device execution button 1012.

In another example, the user terminal 500 may determine the device to provide the live match video as the display device 100 if a button input of the remote control device 200 is detected within a certain period of time after the live match card 1010 is displayed. The user terminal 500 may receive a signal from the server 600 or the display device 100 indicating that a button input of the remote control device 200 has been detected.

Again, FIG. 8 is explained.

Meanwhile, the processor 590 of the user terminal 500 may determine whether there is no live match and whether there is a match scheduled within a certain period of time S827.

The certain period of time may be two weeks, but this is only an example.

The processor 590 of the user terminal 500 may expose a scheduled match card on the display 541 if there is a scheduled match within the certain period of time S829.

When a scheduled match confirmation button included in a scheduled match list card entered through the scheduled match card is selected S831, the processor 590 of the user terminal 500 may display detailed information of the scheduled match on the display 541 S833.

When a calendar view switching button included in the scheduled match list card is selected S835, the processor 590 of the user terminal 500 may display a calendar view including scheduled matches on the display 541 S837.

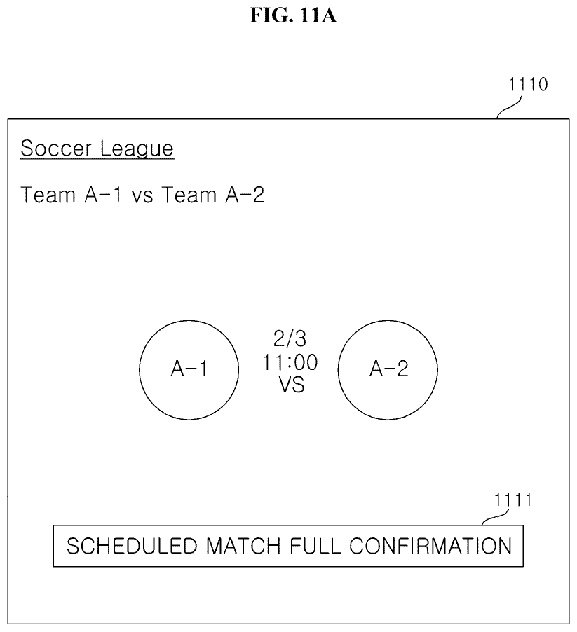

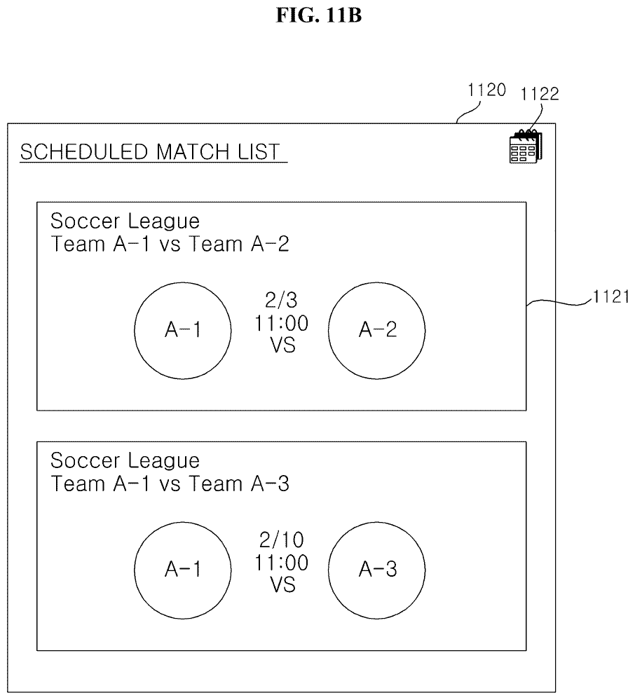

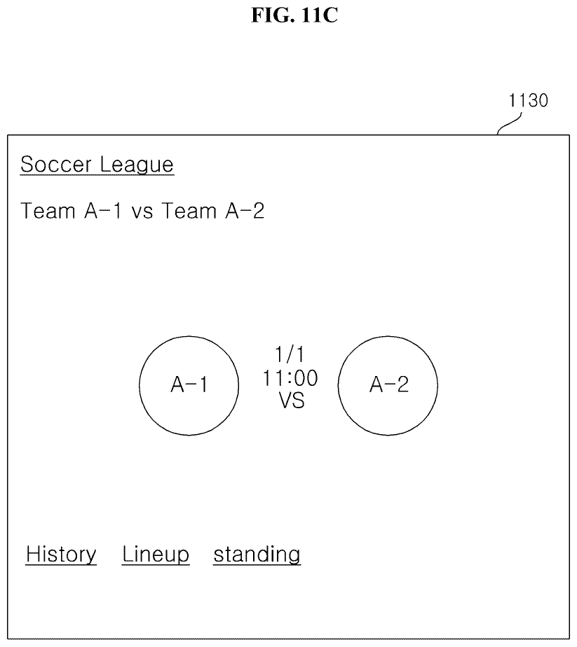

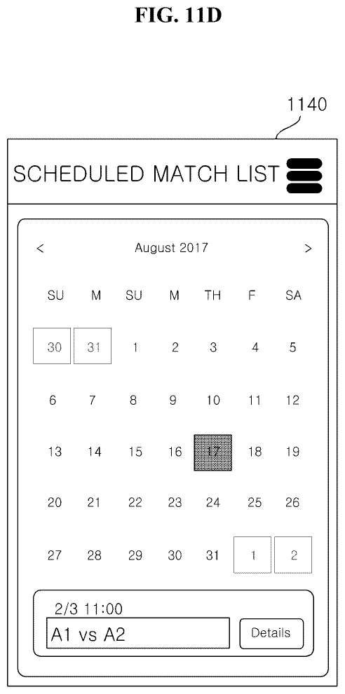

FIGS. 11A to 11D are diagrams showing a process of providing information on a scheduled match when a scheduled match exists based on preferred sports setting information according to an embodiment of the present disclosure.

Referring to FIG. 11A, if there is a scheduled match of a preferred team within a certain period of time based on the preferred sports setting information, the user terminal 500 may display a scheduled match card 1110 including information on the scheduled match on the display 541.

The user terminal 500 may display a scheduled match list screen 1120 on the display 541 as shown in FIG. 11B according to an input of selecting the scheduled match full confirmation button 1111 on the scheduled match card 1110.

The scheduled match list screen 1120 may include scheduled match items 1121 and a calendar view switching button 1122.

When the scheduled match item 1121 is selected, the user terminal 500 may display detailed information 1130 of the scheduled match on the display 541, as shown in FIG. 11C.

When the calendar view switching button 1122 is selected, the user terminal 500 may display a calendar view 1140 showing scheduled matches in a calendar format on the display 541, as shown in FIG. 11D.

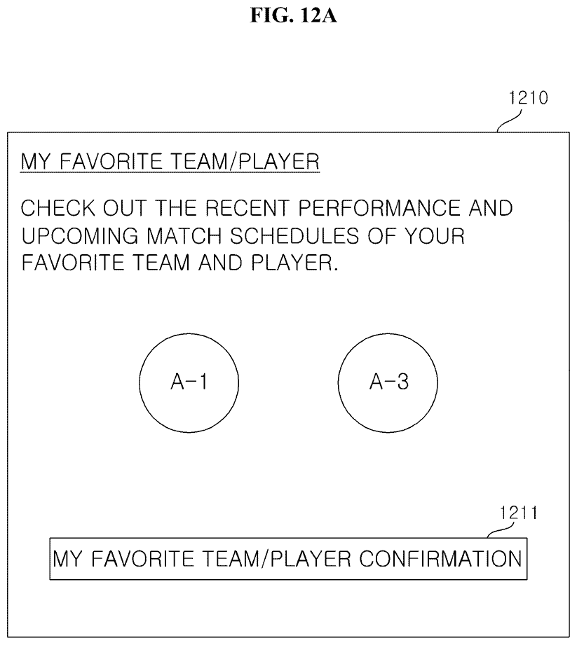

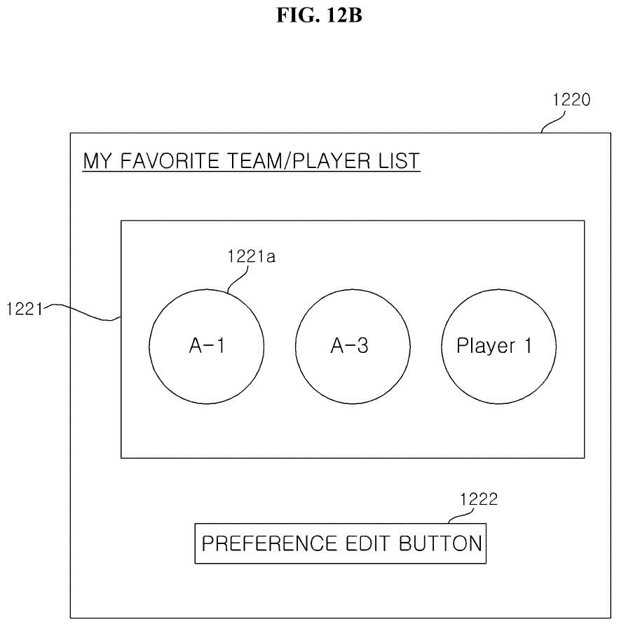

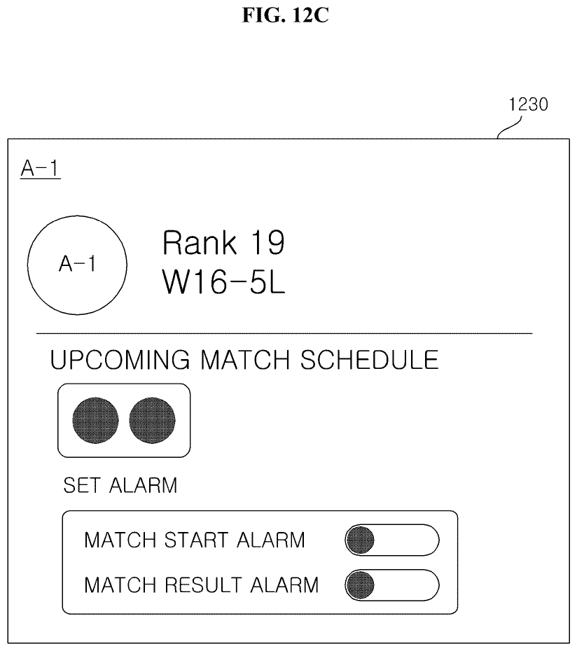

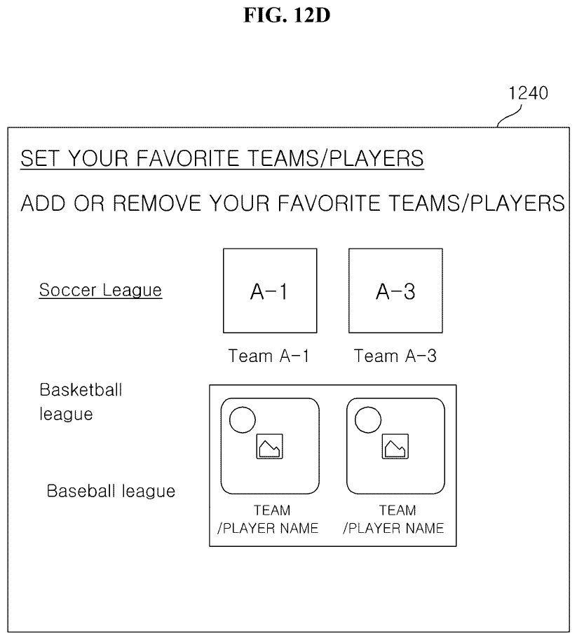

FIGS. 12A to 12D are diagrams illustrating a process for providing information related to a my sports alarm card based on preferred sports setting information according to an embodiment of the present disclosure.

Referring to FIG. 12A, if the preferred sports setting information exists, the user terminal 500 may display a my sports alarm card 1210 on the display 541. The my sports alarm card 1210 may be a button for providing an alarm for preferred teams and preferred players set by the user.

When the confirmation button 1211 on the my sports alarm card 1210 is selected, the user terminal 500 may display a favorite list screen 1220 including favorite teams and favorite players, as shown in FIG. 12B.

The favorite list screen 1220 may include a favorite list 1221 including favorite teams and favorite players and a favorite edit button 1222.

When a team item 1221a included in the preference list 1221 is selected, the user terminal 500 may provide detailed information 1230 of the team corresponding to the selected team item 1221a, as illustrated in FIG. 12C. The detailed information 1230 of the team may include a team's performance, a scheduled match schedule, a button for setting whether to provide an alarm for the start of the match, and a button for setting whether to provide an alarm for the match result.

When the preference edit button 1222 included in the preference list screen 1220 is selected, the user terminal 500 may display the preference sports edit screen 1240 on the display 541, as illustrated in FIG. 12D. The preference sports edit screen 1240 may be a screen for adding or deleting a preference team or a preference player set by the user.

Meanwhile, in the embodiment of FIG. 8, while the home appliance management application is controlled through the user terminal 500, the sports service app of the display device 100 may also be linked in a background.

For example, when a user terminal 500 displays a sports alarm registration card and registers preferred sports setting information, the display device 100 may also execute the sports service app in the background to display the sports alarm registration card and register preferred sports setting information. When a command to execute the sports service app is received or when the sports service app is activated, the display device 100 may display a screen that was being executed immediately before.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like.

The above-described display device is not limited to the configuration and method of the above-described embodiments, but the embodiments may be configured by selectively combining all or part of each embodiment such that various modifications may be made.

What is claimed is:

1. A user terminal, comprising:
a display;
a communication circuit configured to communicate with a server or a display device; and
a processor configured to:
display a match event on the display based on either a notification received from the server or preferred sports setting information corresponding to a user account,
receive a command to select the match event, and
transmit a request for providing detailed information of a match corresponding to the match event to the display device through the communication circuit according to the received command.

2. The user terminal of claim 1, wherein the match event is one of a notification message based on the notification received from the server or a match card generated according to the preferred sports setting information.

3. The user terminal of claim 1, wherein the notification includes live match information or scheduled match information corresponding to the preferred sports setting information.

4. The user terminal of claim 2, wherein the processor is further configured to display, on the display, a first button for providing the detailed information of the match on the user terminal and a second button for providing the detailed information of the match on the display device when the match event is selected.

5. The user terminal of claim 4, wherein the processor is further configured to display a remote control screen for controlling an operation of the display device on the display when the second button is selected.

6. The user terminal of claim 1, wherein the request is a command to cause the display device to run a sports service app to provide the detailed information on the match corresponding to the match event.

7. The user terminal of claim 1, wherein the processor is further configured to:
transmit a power-on command to the display device when a power of the display device is off, and
transmit the request to the display device after the power of the display device is turned on.

8. The user terminal of claim 1, wherein the preferred sports settings information includes information on a user's favorite team or a favorite player.

9. A method of operating a user terminal, comprising:
displaying a match event based on either a notification received from a server or preferred sports setting information corresponding to a user account;
receiving a command to select the match event; and
transmitting a request for providing detailed information of a match corresponding to the match event to a display device according to the received command.

10. The method of claim 9, wherein the match event is one of a notification message based on the notification received from the server or a match card generated according to the preferred sports setting information.

11. The method of claim 9, wherein the notification includes live match information or scheduled match information corresponding to the preferred sports setting information.

12. The method of claim 11, further comprising:
displaying a first button for providing the detailed information of the match on the user terminal and a second button for providing the detailed information of the match on the display device when the match event is selected.

13. The method of claim 12, further comprising:
displaying a remote control screen for controlling an operation of the display device when the second button is selected.

14. The method of claim 9, wherein the request is a command to cause the display device to run a sports service app to provide the detailed information on the match corresponding to the match event.

15. The method of claim 9, wherein the transmitting the request comprises:
transmitting a power-on command to the display device when a power of the display device is off, and
transmitting the request to the display device after the power of the display device is turned on.
